(19) United States
(12) Patent Application Publication
(10) Pub. No.: US 2015/0127418 A1
(43) Pub. Date: May 7, 2015

(54) NOTIFYING AN ADVERTISER OF HIGH ENGAGEMENT POSTS IN A SOCIAL NETWORKING SYSTEM

(71) Applicant: Facebook, Inc., Menlo Park, CA (US)

(72) Inventors: Brian Piepgrass, Mountain View, CA (US); Atol Fortin de Oliveira, San Francisco, CA (US); Bin Jiang, San Francisco, CA (US); Simon Goldman, San Francisco, CA (US)

(73) Assignee: Facebook, Inc., Menlo Park, CA (US)

(21) Appl. No.: 14/070,349

(22) Filed: Nov. 1, 2013

(51) Int. Cl. G06Q 30/02; G06Q 50/00

(52) U.S. Cl. CPC G06Q 30/0201; G06Q 30/0269; G06Q 50/01
USPC 705/7.29

(57) ABSTRACT

To enhance user engagement with a page posts maintained by a social networking system, a social networking system reviews posts associated with a page (e.g., a business or brand page) in a social networking system and measures a degree of user engagement with each post at one or more measures of exposure (e.g., time points or impressions). The social networking system then identifies posts for which the user engagement exceeds a threshold as high engagement or “hot” posts. An administrator associated with the page is notified of the identified high engagement post and can use this information for further promotion or boosting of the identified high engagement post.

### BACKGROUND

This disclosure relates generally to social networking systems, and more specifically to advertising via a social networking system.

Social networks, or social utilities that track and enable connections between users (including people, businesses, and other entities), have become prevalent in recent years and allow users to communicate information more efficiently. Users, such as advertisers, may advertise their brands, products, events or otherwise communicate and disseminate advertisement content to other users via a social networking system. For example, advertisement content may be described by stories indicating other users' interactions with the advertisement content. These stories may be included in newsfeeds presented to social networking system users connected to users performing the interactions. More generally, the social networking system may provide a variety of content with which a user may interact—including a page post, a status update, a photograph, a video, a link, a shared content item, a gaming application achievement, a check-in event at a local business, a brand page, or any other type of content.

However, traditional methods for advertising via social networking systems do not enable advertisers to identify the types of advertisement content that are likely to be popular among users of the social networking system. As a result, these traditional approaches to advertising do not enable advertisers to deliberately produce and advertise content that has a high likelihood of eliciting strong user engagement and popularity.

### SUMMARY

To enable advertisers to identify and emphasize advertisement content that has a high likelihood of eliciting user engagement (e.g., “likes” by users, shares of the content with other users, comments on the content), the social networking system identifies for the advertiser high engagement or “hot” posts that the advertiser can promote or otherwise use to improve future posts. Advertisers can post content in the social networking system (e.g., in the role or capacity of administrators of the content or pages containing the content), and this content posted can be associated with a page. For example, certain pages in the social networking system represent non-user entities or brands, and these pages (or the advertiser behind them, or administrator of the page) can post content to a social networking system, including posting content on the page itself. The posts are then interacted with by users of the social networking system. The social networking system can review posts associated with a page and can identify “hot” posts based on the user engagement with the posts. For example, the social networking system can review each new post that made on a page against feedback levels or interactions that most posts receive to determine if it exceeds a threshold. Posts that exceed the threshold can be identified as “hot” or high engagement posts. The social networking system can communicate the identified high engagement posts to the advertiser or an administrator of the page. The high engagement posts may be used for analytics and/or for prompting the advertiser or page administrator to promote the posts by advertising. Because engagement changes over time, the evaluation of high engagement posts may depend on timing and may reflect a particular snapshot in time.

In one embodiment, the social networking system reviews a set of posts associated with a page in the social networking system. For example, the system can review each post that is made or some number of the posts, and these can be posts on the page or otherwise associated with the page, including posts made by the page itself (or by an administrator of the page). The social networking system measures a degree of user engagement with each post at one or more measures of exposure. A measure of exposure of a post may be a degree or amount (expressed in terms of a measurable or quantifiable unit) representing a lifetime or an age of the post or representing an extent of circulation of the post to social networking system users. The measure of exposure can be, for example, a time period or time duration relative to a time of creation of the content or a number of user impressions or views of the advertisement content. User engagement can be measured, for example, as a total number of user interactions with the content or a total number of user interactions normalized to a total number of user impressions of the content. The social networking system further identifies as “hot” posts the posts having a degree of user engagement greater than a threshold user engagement level for at least one time point or per number of impressions. For example, the social networking system can compare a value of the user engagement at a given point in time or at a given number of user impressions against a threshold user engagement value for that given point in time or at a given number of user impressions to determine whether the user engagement value exceeds the threshold user engagement value. If so, the content is deemed to have a high user engagement at that point in time or for that number of user impressions. The social networking system notifies the advertiser or page administrator when a post is determined to be a high engagement post. Based on such a notification, the advertiser or administrator may then boost or promote the identified high engagement post to the top of the page or other pages (e.g., in newsfeed), or may visually highlight the post on the page or on other pages (e.g., in newsfeed) to make it more prominent.

### BRIEF DESCRIPTION OF THE DRAWINGS

FIG. 1 is a block diagram of a system environment in which a social networking system operates, in accordance with some embodiments.

FIG. 2 is a block diagram of a social networking system, in accordance with some embodiments.

FIG. 3a-3b are examples user interfaces illustrating pages and posts related to pages in a social networking system, in accordance with some embodiments.

FIGS. 4a-4b are example user interfaces for promoting posts related social networking system to social networking system users, in accordance with some embodiments.

FIGS. 5a-5b include traces illustrating trends and variations in user engagement levels with posts as a function of an aggregate count of impressions (FIG. 5a) and as a function of time (FIG. 5b), in accordance with some embodiments.

FIGS. 6a-6b are examples of user interfaces for providing information describing one or more promoted posts, in accordance with some embodiments.

FIGS. 7a-7b are a flowchart of a method for notifying an advertiser when a post elicits at least a threshold value of user engagement for a given measure of exposure, in accordance with some embodiments.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### System Architecture

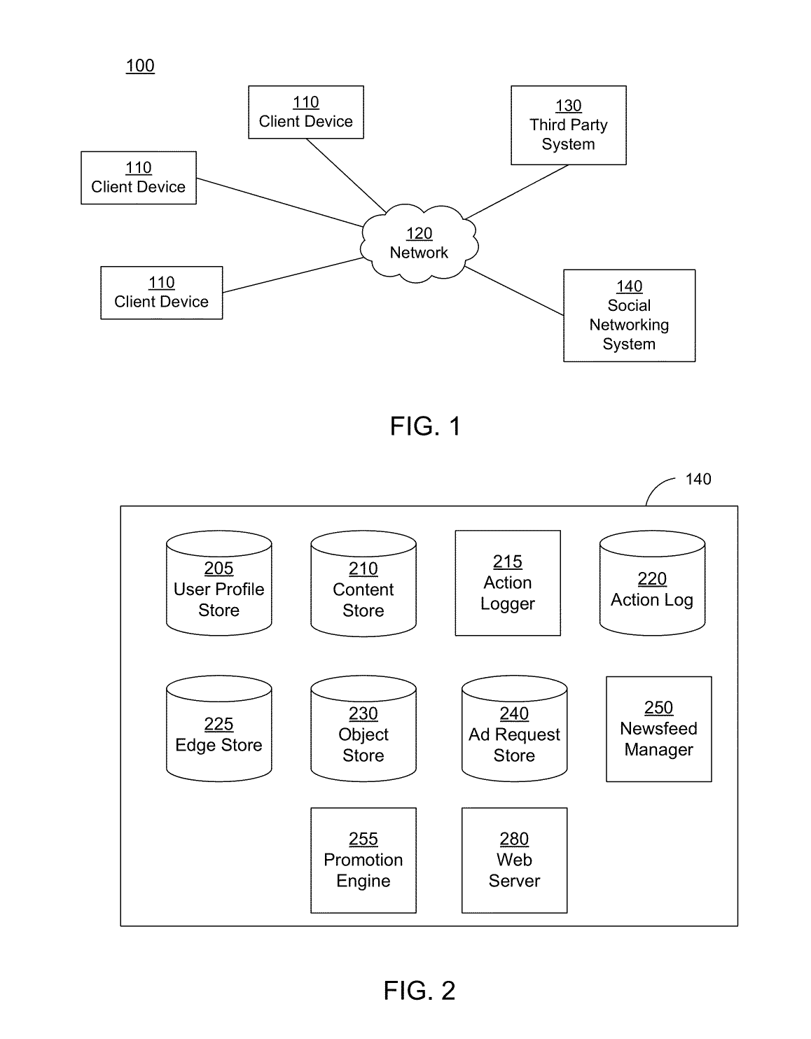

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 1. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130.

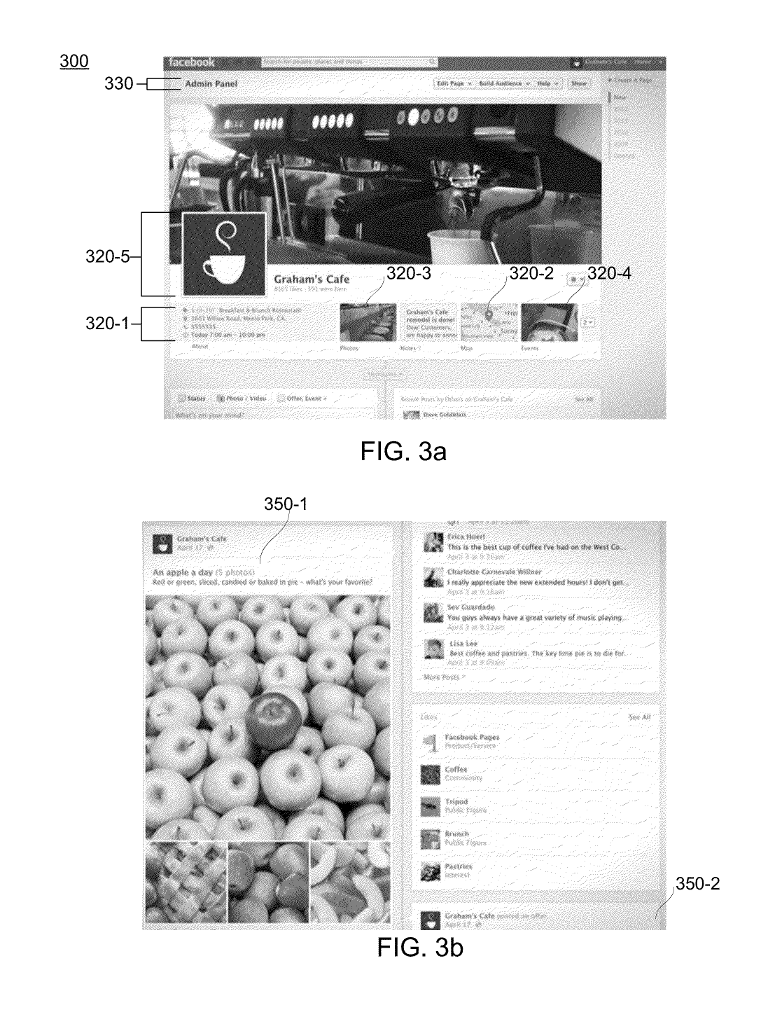

FIG. 2 is an example block diagram of an architecture of the social networking system 140. The social networking system 140 shown in FIG. 2 includes a user profile store 205, a content store 210, an action logger 215, an action log 220, an edge store 225, an object store 230, ad request store 240, newsfeed manager 250, and a web server 280. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 230 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the advertisement request store 240. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, the targeting criteria may specify actions or types of connections between a user and another user or object of the social networking system 140. The targeting criteria may also specify interactions between a user and objects performed external to the social networking system 140, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

Furthermore, an advertisement request may include timing information specifying a time of rendering of an advertisement to one or more users of the social networking system. Timing information included in an advertisement request specifies a specific time instance or duration of time at or during which the advertisement is displayed to one or more social networking system users eligible to be presented with advertisement content in the advertisement request.

In one embodiment, the social networking system 140 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager 250 may generate stories for presentation to a user based on information in the action log 220 and in edge store 225 or may select candidate stories included in content store 210. One or more of the candidate stories are selected and presented to a user by the newsfeed manager 250.

For example, the newsfeed manager 250 receives a request to present one or more stories to a social networking system user. The newsfeed manager 250 accesses one or more of the user profile store 205, the content store 210, the action log 220, and the edge store 230 to retrieve information about the identified user. For example, stories or other data associated with users connected to the identified user are retrieved. The retrieved stories or other data are analyzed by the newsfeed manager 250 to identify content likely to be relevant to the identified user. For example, stories associated with users not connected to the identified user or stories associated with users for which the identified user has less than a threshold affinity are discarded as candidate stories. Based on various criteria, the newsfeed manager 250 selects one or more of the candidate stories for presentation to the identified user. Additionally, the newsfeed manager 250 may select candidate stories based in part on compensation received by the social networking system 140 for presenting a candidate story to one or more users. This allows an advertiser or other entity to sponsor a story for presentation to social networking system users. Examples of stories sponsored by advertisers or entities (“sponsored stories”) are described in U.S. application Ser. No. 12/193,702, filed Aug. 18, 2008, published as U.S. Patent Application Publication No. 2009/0119167, which is incorporated in its entirety by reference herein.

In various embodiments, the newsfeed manager 250 presents stories to a user through a newsfeed including a plurality of stories selected for presentation to the user. The newsfeed may include a limited number of stories or may include a complete set of candidate stories. The number of stories included in a newsfeed may be determined in part by a user preference included in user profile store 205. The newsfeed manager 250 may also determine the order in which selected stories are presented via the newsfeed. For example, the newsfeed manager 250 determines that a user has a highest affinity for a specific user and increases the number of stories in the newsfeed associated with the specific user or modifies the positions in the newsfeed where stories associated with the specific user are presented.

The newsfeed manager 250 may also account for actions by a user indicating a preference for types of stories and selects stories having the same, or similar, types for inclusion in the newsfeed. Additionally, the newsfeed manager 250 may analyze stories received by social networking system 120 from various users to obtain information about user preferences or actions from the analyzed stories. This information may be used to refine subsequent selection of stories for newsfeeds presented to various users.

The promotion engine 255 stores data for customizing distribution of content associated with the object. For example, the promotion engine 255 accesses the user profile store 205 to identify users having one or more characteristics identified by targeting criteria stored in the promotion engine 255. As another example, the promotion engine 255 may also access stored budget information or bid amounts associated with stories, or other content, and provide the newsfeed manager 250 with the bid amounts and/or budgets for use in generating a ranked list of stories based on budget and/or bid amount. Additionally, the promotion engine 255 may request payment information from a promoting user for placing a bid amount associated with a story (e.g., payment to promote or boost a “hot” post).

In some embodiments, the promotion engine 255 may communicate content associated with an object being promoted to client devices 110 of viewing users (e.g., communicate a boosted “hot” post). For example, if the content is a sponsored story or other advertisement the promote engine 255 may serve the sponsored story based on data associated with it, such as targeting criteria, bid amount or similar data. Hence, the data provided by a user authorized to promote an object is stored and applied by the promotion engine 255 to modify presentation of content to viewing users, including promoting or emphasizing “hot” posts. The promotion engine 255 may also provide a promoting user with information describing the effectiveness of story promotion based on information from the newsfeed manager 250. For example, the promotion engine provides information describing the difference between the number of times a promoted story has been presented to viewing users and the number of times the story would have been presented to viewing users without promotion.

The web server 280 links the social networking system 140 via the network 120 to the one or more client devices 110, as well as to the one or more third party systems 130. The web server 280 serves web pages, as well as other web-related content, such as JAVA®, FLASH®, XML and so forth. The web server 280 may receive and route messages between the social networking system 140 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 210. Additionally, the web server 280 may provide application programming interface (API) functionality to send data directly to native client device operating systems, such as IOS®, ANDROID™, WEBOS®, or BlackberryOS.

### Pages and Posts

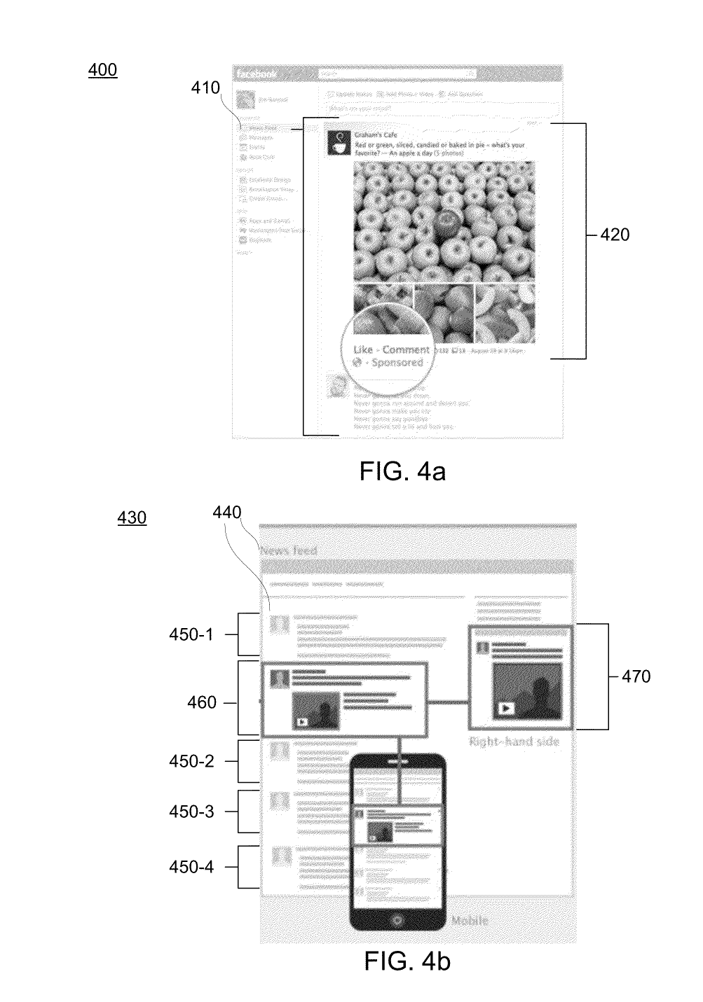

FIGS. 3a-3b show examples of user interfaces illustrating pages in a social networking system. FIG. 3a illustrates an example of a page 300, such as a page in the social networking system that represents a real-world entity or commercial brand, or a page representing any other content which the page administrator might wish to promote. Pages 300 can also include a user's own page or profile, a page associated with a public figure, a page for an event, a newsfeed page, or other pages within the social networking system.

In the example shown in FIG. 3a, the page 300 is associated with a real-world entity, which in this case is a commercial business or enterprise (e.g., Graham's Cafe) and the page associated with the entity or the commercial enterprise is a profile page displaying information about the entity. In the example of FIG. 3a, the page 300 displays one or more geographic locations, contact information and business hours 320-1, maps 320-2, graphical content 320-3, event information 320-4, and a logo 320-5; additional information about the entity may also be displayed. In some embodiments, an advertiser associated with the entity (e.g., the owner of the entity or a content developer authorized by the owner of the entity, such as a page administrator) has administrative rights to modify content presented by the page or access to the page. In the example of FIG. 3a, the example page 300 is shown as accessed by an administrative account 330 associated with a social networking system user having administrative rights to modify content presented by the page 300, remove content presented by the page 300, restrict content presented by the page 300, or perform other modifications of content associated with the page 300.

In some embodiments, such as the embodiment shown in FIG. 3b, one or more posts 350-1, 350-2 are presented in association with the page. For example, one or more posts 350-1, 350-2 are displayed on the page 300 (e.g., displayed on a page). A post 350-1, 350-2 may include advertising information about the entity (e.g., information about social or community events associated with the entity, information about products or services sold by the entity, etc.), educational information about the entity (information about new products or services, new retail locations of the entity, etc.), promotional offers (e.g., discounts, sales, etc.), or other information describing the entity associated with the page.

Posts 350-1, 350-2 displayed or presented in association with the page can be created by an authorized user of the social networking system. For example, a user with administrative permission to create content associated with the page 300 creates one of more posts 350-1, 350-2. Posts displayed in association with the page can also be created by social networking system users, other than users with administrative permission, that are connected to the page (e.g., “liked” the page) or that otherwise interact with the page. Various types of content may be included in a post 350-1, 350-2. For example a post 350-1, 350-2 includes text data, graphical data, video data, metadata, links to additional content, audio data, or any other suitable type of data. One or more social networking system users that are connected to the page 300 or that have interacted with the page 300 may also interact with posts 350-1, 350-2 associated with the page 300. Examples of user interactions with a post 350-1, 350-2 include providing a comment associated with a post 350-1, 350-2, expressing a preference for the post 350-1, 350-2 (e.g., “liking” the post 350-1, 350-2), sharing the post 350-1, 350-2 with another social networking system user, or any other suitable interaction.

In some embodiments, a post 350-1, 350-2 associated with the page 300 identifies the page 300 but is presented separately from the page 300. For example, a user that is not connected to the page 300 or that has not interacted with the page 300 may generate a post to another user's profile page that identifies the page 300. This post is not presented in association with the page 300, but identifies the page 300 or content associated with the page 300.

### Promoting Posts to Social Networking System Users

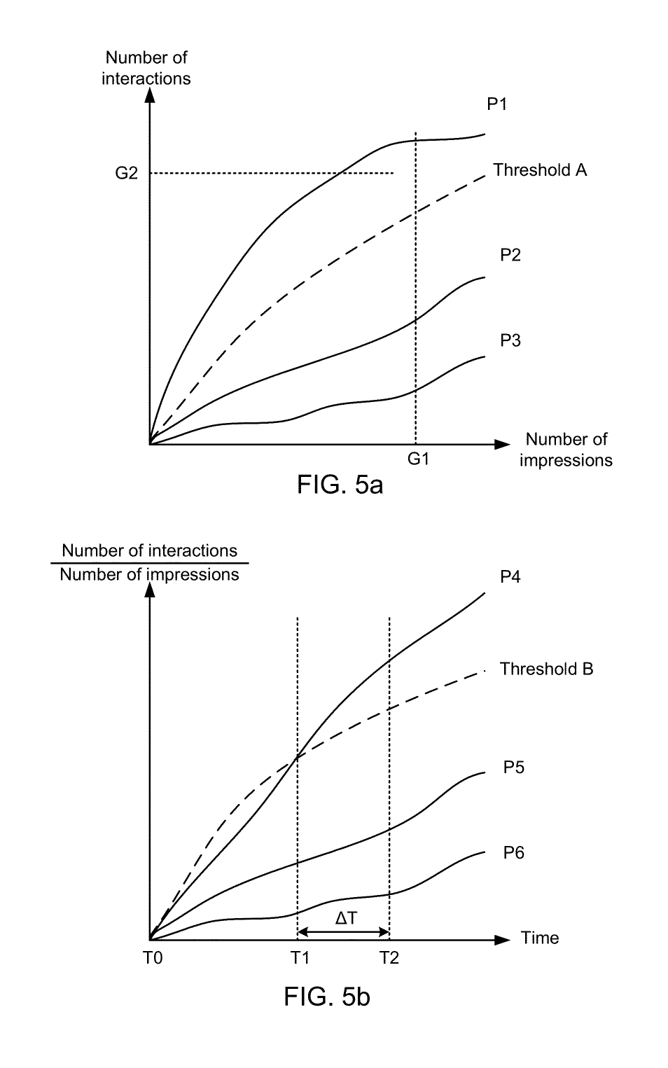

Advertisers associated with an entity, such as a brand, often seek to promote the entity to social networking system users. Frequently, advertisers seek to promote an entity to social networking system users that have not previously interacted with the entity but that are likely to have an interest in interacting with objects associated with the entity. The extent to which a social networking system user is likely to interact with a page or a post related to a page may depend on a point in time at which the user views the page or the post. For instance, in the example of FIGS. 3a-3b and 4a, a user may be more likely to view a post that advertises a new flavor of apple pie introduced by Graham's Cafe during a introductory or promotional period when a plurality of users are interacting with the post (e.g., liking or commenting on the post). Accordingly, an advertiser associated with Graham's Cafe may wish to promote the post related to the new promotional flavor of apple pie during this promotional period.

To increase the statistical likelihood of user interaction with pages or posts associated with the pages, the social networking system reviews posts associated with an advertiser to identify posts that are popular among users of the social networking system (i.e., posts that elicit greater than a threshold value of user engagement). These are considered to be high engagement posts or “hot” posts. These high engagement posts can be identified to the advertiser. The advertiser may then boost or promote or otherwise emphasize these high engagement posts so that they are made prominently available to additional social networking system users such that users have a strong likelihood of interacting with the posts. In some embodiment, a high engagement or hot post is considered hot only for a period of time, and so the notification of a hot post expires after a certain number of days (e.g., 3 days).

FIGS. 4a and 4b are examples of user interfaces for promoting posts associated with an object to social networking system users. For example, one or more of the user interfaces described by FIGS. 4a and 4b allow a post, having at least a threshold amount of user interaction by users at a given instance in time or for a given number of user impressions, to be promoted such that it is emphasized or made more prominent for additional social networking system users. A post that provided the threshold amount of user interaction with the post may be identified to an advertiser who may then prompt the social networking system to present the post to additional users.

In the example shown by FIG. 4a, a post is presented as a story 420 in a newsfeed 410 presented to a social networking system user (a “viewing user”). The story 420 may include content from the post, a description from the post, and one or more options for the viewing user to interact with the post (e.g., comment on the post, express a preference for the post, share the post with another user, etc.). In some embodiments, information describing prior user interaction with the post may also be included in the story 420.

FIG. 4b shows an additional example of a newsfeed 440 presented by the social networking system to the viewing user. The newsfeed 440 includes stories 450-1, 450-2, 450-3 describing actions performed by other social networking system users connected to the viewing user or other organic content. Additionally, as shown in FIG. 4b, the newsfeed 440 may include one or more sponsored stories 460 that include posts promoted by an advertiser or entity. The social networking system receives compensation from an advertiser or entity to include a sponsored story 460 in a newsfeed 440. For example, an advertiser provides monetary compensation to the social networking system for generating and presenting a sponsored story 460 to a social networking system user.

In some embodiments, the story 460 includes content from an identified post eliciting at least the threshold user engagement (i.e., a popular or high engagement post). A high engagement post that is promoted or boosted by an advertiser might be emphasized or made more prominent in some fashion (e.g., moved to the top of a page or a newsfeed or within the top X number of stories in the page or newsfeed). In some embodiments, story 460 is visually emphasized in the user's newsfeed 440 so as to visually distinguish story 460 from other organic content 450-1, 450-2, and so on, and optionally from other sponsored stories. Examples of visual emphasizing story 460 include starring story 460 or the post contained within story 460, uniquely color coding or highlighting story 460, placing story 460 in a predefined spatial region in the viewing user's newsfeed 440 (e.g., in a top region of the newsfeed 440 or in a central portion of newsfeed 440), displaying the post (or corresponding sponsored story 460) in a display area greater than a predefined display area conventionally used to set display size for other organic content 450-1, 450-2 or other sponsored stories, labeling story 460 to indicate that the post contained within story 460 elicited at least the threshold level user engagement, providing a visual demarcation (e.g., outline) around story 460, overlaying the story 460 over at least a portion of the newsfeed 440 (e.g., superimposing story 460 in a vertical dimension over the newsfeed 440, with the newsfeed 440 in the background) for a predetermined period of time to emphasize the post to a viewing user, and the like.

However, in some embodiments, a post associated with a page is presented to the viewing user in an advertisement 470 displayed separate from the newsfeed 440, and optionally alongside the newsfeed 440. In other words, rather than present a post in a story presented in a newsfeed, a post may be presented in an advertisement presented to a user in addition to the newsfeed. In some embodiments, an advertisement containing a post identified as having at least a threshold level of prior user engagement is selected for presentation to additional users at a time point after the identified post meets at least the threshold level of prior user engagement.

Furthermore, an identified high engagement post may be visually emphasized on the advertiser's page (e.g., on the page for Graham's Cafe) itself. Examples of visually highlighting the identified post include uniquely color coding the post, visually demarcating the post, starring the post, placing the post in a predefined and prominent spatial region of the page (e.g., upgrading the placement of the post to the top of the page or in a central portion of the page), displaying the post in a display area greater than a predefined display area conventionally used to set display size for other post on the page, overlaying the post over at least a portion of the page (e.g., superimposing the post in a vertical dimension over the page, with the page in the background) for a predetermined period of time to emphasize the post to a viewing user, or otherwise boosting visual prominence of the post to draw user attention to the post.

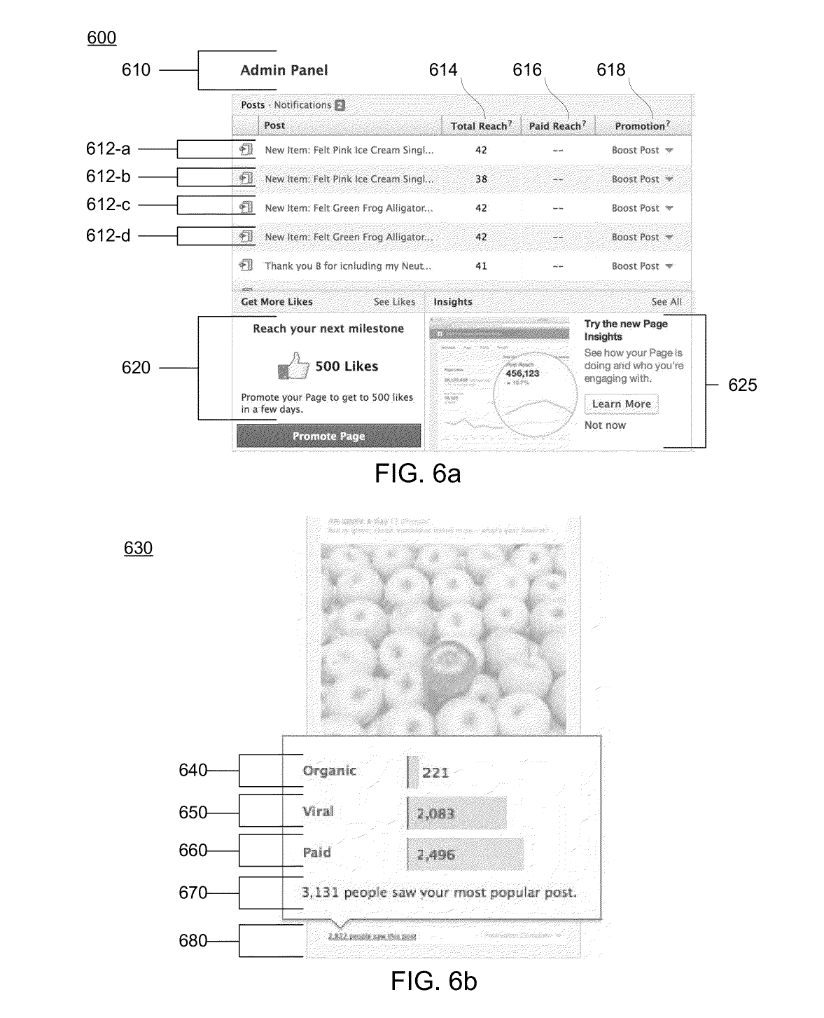

FIGS. 5a-5b include traces illustrating trends or variations in user engagement levels with posts as a function of an aggregate count of impressions (FIG. 5a) and as a function of time (FIG. 5b), in accordance with some embodiments. When a post is presented to a viewing user, after and in spite of having viewed the post, the viewing user may or may not interact with (e.g., perform an engagement event, such as like or express a preference for, comment on, or share) the post. As a result, a number of user interactions with or engagement events of a post are typically lower than a cumulative or aggregate number of user impressions or views of the post—resulting, typically, in a certain amount of discrepancy between the exposure, or extent of dissemination, of the post and a measure of user interaction or number of engagement events for the post. But the degree or amount of discrepancy between the measure of exposure and the measure of user interaction may provide valuable information about the popularity of the post among users of the social networking system. Additionally, the amount of discrepancy may vary with the measure of exposure of the post, for example, with time (measured relative to a time of creation of a post) or with a number of impressions of the post.

In some embodiments, the advertiser may wish to observe and analyze user engagement statistics corresponding to various posts created in association with the advertiser's page. For example, the advertiser may wish to analyze statistical trends (e.g., review a trend of user engagement with a user impressions, or with time) for popular posts that elicited above a threshold value of user engagement, posts that were not popular among social networking system users (e.g., posts that did not elicit above a threshold value of user engagement), and the so on. The advertiser (e.g., an admistrator of the page, the entity associated with the page, the other third party entity), or the social networking system itself may train a statistical prediction model to subsequently identify or predict popular posts, posts that did not elicit greater than a threshold value of user engagement, and the like based on previously observed and analyzed trends for these categories of posts. The advertiser can further promote or emphasize a popular post to one or more users when the post exceeds a threshold value of user engagement to further capitalize on the popularity of the post.

FIG. 5a illustrates, for each of a plurality of posts P1, P2, and P3, a trend of user engagement as a function of exposure. As described previously, a measure of exposure of a post may be a degree or amount (expressed in terms of a measurable or quantifiable unit) representing a lifetime or an age of the post or representing an extent of circulation of the post to social networking system users. In the illustration shown in FIG. 5a, the posts P1, P2, and P3 are optionally new or recently created posts (posts created within a predetermined interval of time prior to a time of review or trending) associated with a page; user engagement is measured as a total number of user interactions (e.g., engagement events performed by viewing users on the post) with the post; and exposure is measured as a cumulative or aggregate number of user impressions (e.g., a number of views) of the post. A threshold user engagement level (e.g., Threshold A) is defined; the threshold user engagement level is used to determine whether a particular post elicits high user engagement.

For a given number of user impressions, the threshold user engagement level (e.g., value of Threshold A) varies based on a cumulative measure of user engagement with previously observed posts (e.g., posts associated with the page or with the advertiser or posts that occur globally on the social networking system). In some embodiments, at a given number of user impressions, a value of Threshold A may vary as a predetermined percentage of the total measure of user interactions with the previously observed posts—for example, at 1000 impressions, the value of Threshold A may be 90% of a total number of interactions with a certain set of posts when each post of that certain set of posts had 1000 impressions, whereas at 5000 impressions, the value of Threshold A may be 85% of a total number of interactions with the certain set of posts when each post of that certain set of posts had 5000 impressions. Similarly, a value of Threshold A may vary as a weighted percentage of the total measure of user engagement with previously observed posts for the given number of user impressions; or as any other mathematical function of the total measure of user engagement with all of the previously observed posts for the given number of user impressions.

At a given measure of exposure (e.g., number of impressions in FIG. 5a), a post having a measure of user engagement greater than a threshold user engagement value for that given measure of exposure is identified to the advertiser as a popular or high engagement post. In the illustration of FIG. 5a, post P1 is a high engagement post for each of the measures of exposure (e.g., a cumulative counts of user impressions) shown; posts P2 and P3 on the other hand do not elicit a measure of user interactions greater than a threshold user engagement value at any measure of exposure and therefore would not be identified as high engagement posts. The advertiser, in turn, may boost, promote, highlight, or otherwise emphasize the high engagement post so as to further increase user engagement for the post.

In some embodiments, a high engagement post P1 is promoted by the advertiser until a goal G1 corresponding to a target number of impressions has been reached. Alternatively, or in addition, the high engagement post P1 is promoted until a goal G2 corresponding to a target number of interactions has been reached.

FIG. 5b illustrates, for each of a plurality of posts P4, P5, and P6, a trend of user engagement as a function of measure of exposure. In the example of FIG. 5b, user engagement is measured as a ratio of a total number of user interactions or engagement events to a total number of user impressions; measure of exposure is measured as a time instance or time point relative to a time (T0) of creation of each of the plurality of posts P4, P5, and P6.

It should be understood that time point T0 in FIG. 5b need not correspond to the same instant in time based on a real-time measurement or reference, like a real-time clock measurement. However, since the time axis for FIG. 5b represents time points relative to time of post-creation, the origin (T0) of this axis commonly represents the time of creation of posts P4, P5, and P6; but the posts P4, P5, and P6 may in practice be created at different points in time measured as referenced by a real-time clock measurement.

Furthermore, in alternative embodiments, when a time instance or time point relative to a time of post-creation is used as a measure of exposure, user engagement is measured based on a total number of interactions or engagement events. This representation of user engagement may provide useful information to an advertiser associated with a page, when comparing user engagement statistics or trends for various posts for the same page. In such embodiments, a threshold user engagement level is customized to the page, to a typical number of interactions with a post for that page, based on the number of connections to that page, or any combinations thereof.

Threshold user engagement level (Threshold B), shown in FIG. 5b, has a predetermined relationship with time of creation of the post—for example, predefined based on past trends of high engagement or popular posts, based on a popularity of the page, based on a popularity of the advertiser, or based on any other fixed threshold such as an advertiser-specified threshold. A high engagement post has, at a given instance in time relative to a time of creation of the post, a measure of engagement (e.g., a number of interactions normalized to a number of user impressions) greater than the threshold user engagement level for the given instance in time.

Accordingly, post P4 is not determined to be a high engagement post until time point T1. At time point T1, a measure of user engagement for post P4 crosses a value of Threshold B, and post P4 is determined to be a high engagement post at and after time point T1. A high engagement post may be associated with an advertiser-specified period of promotion validity ΔT during which the post is deemed suitable by the advertiser for boosting, emphasizing, or promoting to one or more additional social networking system users. In the example of FIG. 5b, the period of promotion validity extends from time point T1 to time point T2, but this period of validity could start at any time point (e.g., as specified by the advertiser) subsequent to time point T1 at which the post P4 is determined to be a high engagement post. Similarly, one or both of the time points of T1 or T2 could be set by the social networking system.

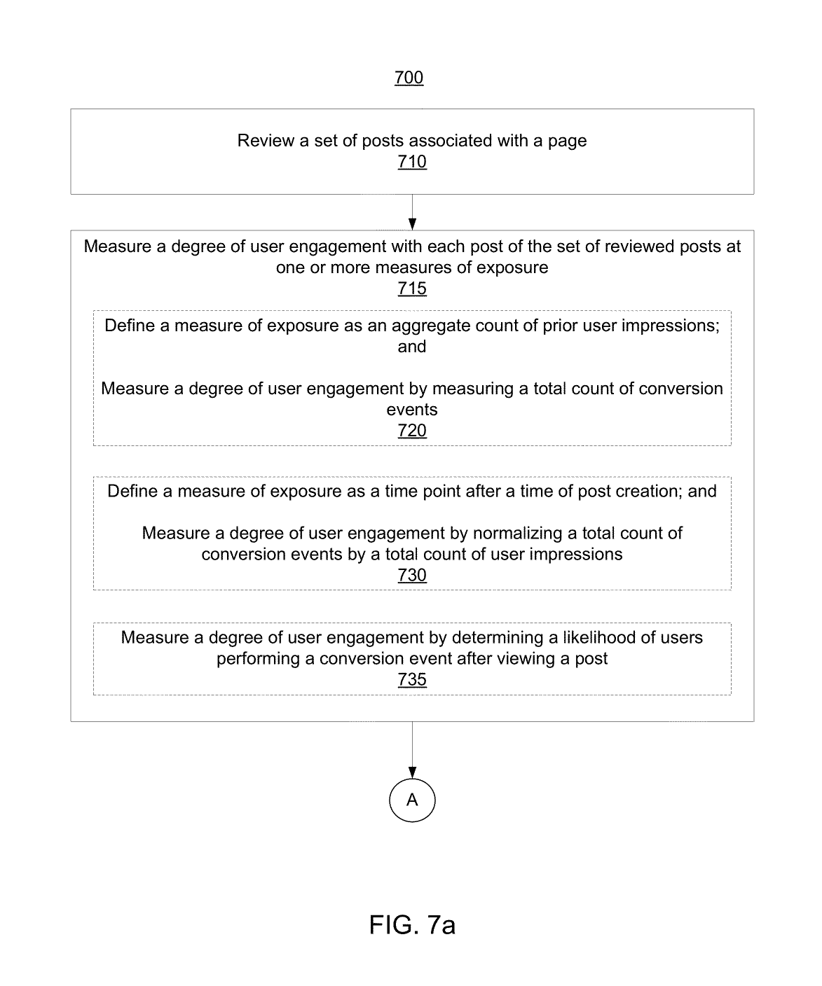

FIG. 6a is an example user interface 600 providing information about presentation of one or more recently created posts to an advertiser. The social networking system may provide various information describing posts created by the entity or the advertiser. In addition, the social networking system may display statistics (e.g., user engagement statistics and/or user exposure statistics) regarding the posts to the advertiser, to the entity associated with the page, or to any other third party entity.

As shown in FIG. 6a, user interface 600 is accessed by an advertiser, via administrative account 610, associated with the entity (e.g., the owner of the entity or a content developer authorized by the owner of the entity), who has administrative rights over by the page. When accessed from the administrative account 610, the user interface 600 may display a list of posts 612 (including recently created posts 612-a, 612-b, 612-c, and so on; created within a predetermined duration of time prior to a time of display), associated with the advertiser's page—including, for example, recent posts created by the advertiser or the entity, recent posts created by one or more other users of the social networking system, and so on. These posts 612-a, 612-b, 612-c may be displayed based on an order in which the posts 612 were created or a time of creation of the posts 612, or may be sorted based on one or more attributes associated with the posts 612. User interface 600 may display statistical information describing one or more of the posts 612—including a total reach 614 of the posts (i.e., a total measure of exposure or a total number of impressions), a paid reach 616 (i.e., a total measure of exposure or a total number of impressions in return for which the advertiser provided the social networking system monetary compensation), an option to boost or promote 618 the posts, and so on.

The user interface 600 may optionally include a recommendation for a goal or milestone 620 (e.g., a target number of user impressions or a target number of user interactions or engagement events) that the advertiser may achieve by boosting or promoting one or more of the posts 612. Additionally, the user interface 600 may display trends 625 illustrating, for example, variations in user engagement with measures of user exposure of one or more of the posts 612. Examples of such trends are illustrated in FIGS. 5a-5b.

FIG. 6b is another example user interface for providing information (e.g., statistics) about presentation of a particular post (e.g., a high engagement post) to social networking system users, such as to the advertiser, to the entity associated with the object being promoted, or to any other third party entity. The social networking system may provide various information describing the nature of engagement and/or exposure of a post. In the example of FIG. 6b, the social networking system presents a total number of impressions of a post 680 (i.e., a total number of users who viewed the post), a number of users to whom the post was presented as organic content 640, a number of users to whom the post was presented as viral content 650 (i.e., a number of users that were presented with the post from one or more other social networking system users, rather than directly from the advertiser or the entity), and a number of users to whom the post was presented as paid content 660 (i.e., a number of users that were presented with the post in exchange for the social networking system receiving compensation from an advertiser or entity). To provide additional information or context about user engagement of a post, a total number 670 of users who viewed or interacted with a most popular post associated with an entity associated with the post may also be presented.

### Identifying Posts Eliciting High User Engagement

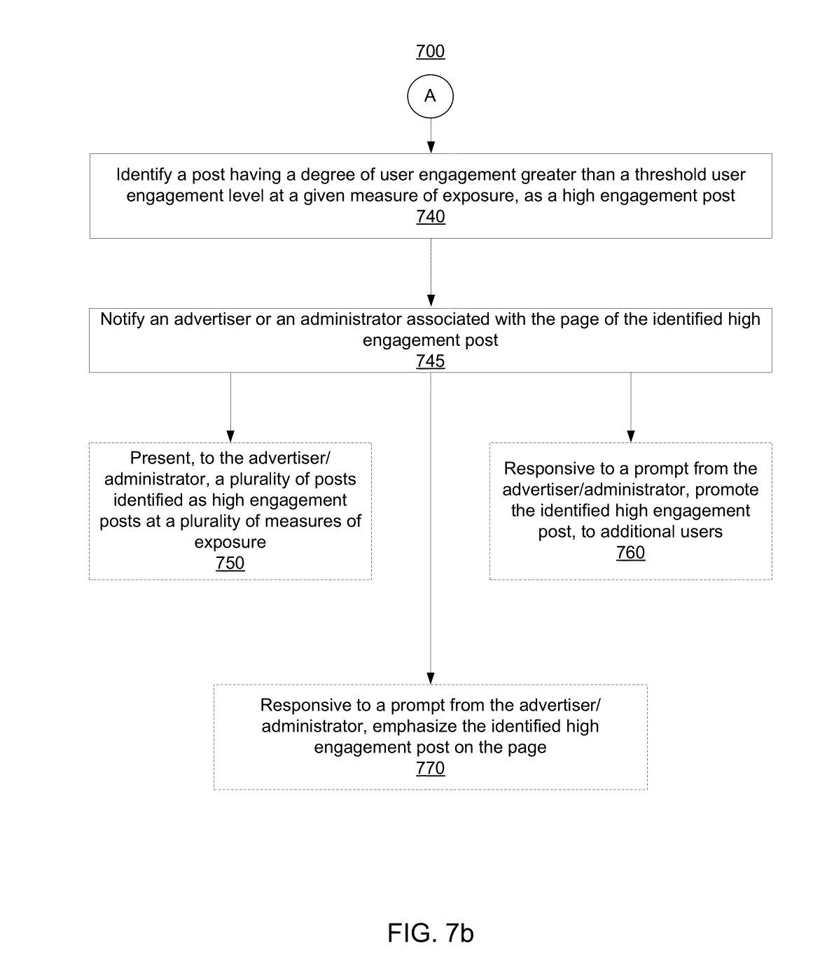

FIGS. 7a-7b are flowcharts of one embodiment of a method 700 for notifying an advertiser when a post elicits at least a threshold value of user engagement for a given measure of exposure, according to some embodiments.

The social networking system reviews 710 a set of posts associated with a page in the social networking system. In some embodiments, the set of reviewed posts include posts that are recent posts. Recency of posts is optionally determined based on criteria such as a time of creation the posts (e.g., created not more than a predetermined time period prior to a time of review or within a certain time window of the time of review) or prior user impressions of the posts (e.g., posts have less than a predetermined number of user impressions or views). In alternative embodiments, the social networking system reviews all posts that are created for a page.

For example, a business page, such as a profile page for Graham's Cafe (as shown in FIGS. 3a-3b), displays posts 350-1 and 350-2 on the profile page; the posts created by an administrator associated with the profile page or by one or more other users of the social networking system. The social networking system reviews one or more recently created posts (e.g., the post 350-1 about a promotional sale for a new flavor of apple pie) associated with Graham Cafe's profile page as and when the posts are created—e.g., within a predetermined interval of time of the posts being created.

The social networking system measures 715 a degree of user engagement with each of the reviewed posts at one or more measures of exposure.

In some embodiments, and as explained further with reference to FIG. 5a, a measure of exposure for a particular reviewed post is defined 720 as an aggregate count of prior user impressions (e.g., views) of the particular post, and a degree of user engagement with the particular post, is measured, at a particular aggregate count of prior user impressions, by measuring a total count of interactions or engagement events, from among the prior user impressions. Various examples of user interactions and engagement events are described with reference to FIGS. 5a-5b above.

In alternative embodiments, and as explained further with reference to FIG. 5b, a measure of exposure for a particular reviewed post is defined 730 as a time point after a time of creation of the particular post, and a degree of user engagement with the particular post, is measured, at the time point after the time of creation of the particular post, by: normalizing a total count of engagement events associated with the particular post up until the time point by a total count of user impressions of the particular post up until the particular time point. In such embodiments, a total count of engagement events associated with the particular post up until the time point is measured. Further, a total count of user impressions of the particular post up until the particular time point is measured. The total count of engagement events is then normalized by the total count of user impressions.

In some embodiments, a degree of user engagement with a particular reviewed post is measured 735, by determining or predicting a likelihood (e.g., a statistically computed likelihood) of one or more users of the social networking system performing an engagement event after being presented with the particular post. For example, a likelihood of a user performing an engagement event is predicted based on engagement events performed when users were presented with a post having one or more attributes similar to the particular post—for example, based on engagement events performed by users on other similar posts previously posted to the social networking system (e.g., having similar topics, keywords, subject matter, associated with the same page, associated with the same advertiser, and so on).

The social networking system identifies 740, from the set of reviewed posts, at a given measure of exposure, a post having a corresponding degree of user engagement that exceeds a threshold user engagement level for the given measure of exposure. Such a post is identified as a high engagement post. For example, referring to FIG. 5b, post P4 is identified as a high engagement at and after time T1 at which a measure of user engagement for post P4 exceeds a value of Threshold B.

In some embodiments, the threshold user engagement level at a given measure of exposure (e.g., point in time or number of total user impressions) is computed based on a predetermined percentage of a cumulative measure of user engagement with one or more other posts at that point in time or for that number of total user impressions. The one or more other posts may or may not be posts associated with the page.

In some embodiments, the threshold user engagement level for the given measure of exposure (e.g., point in time or number of total user impressions) has a predefined relationship with the given measure of exposure. In such embodiments, the predefined relationship is defined based on past trends of popular posts (e.g., posts that elicit a predefined trend or amount of user engagement), based on a popularity of the page, based on a popularity of the advertiser, or based on any other predefined threshold (e.g., an advertiser-specified threshold).

The social networking system notifies 745 an advertiser or a page administrator associated with the page of the identified high engagement post. In some embodiments, the notification is provided to the advertiser or the page administrator at the given measure of exposure or substantially at the given measure of exposure. For example, referring to FIG. 5b, the notification is provided to the advertiser or the page administrator at time point T1 when a measure of user engagement for post P4 exceeds Threshold B. In alternative embodiments, the notification is provided to the advertiser or the page administrator at a measure of exposure subsequent to the given measure of exposure (e.g., referring again to FIG. 5b, the notification may be provided at a time point subsequent to time T1).

In some embodiments, the advertiser or the page administrator may collect information (e.g., statistics and trends) regarding popular or high engagement posts (e.g., posts having greater than a threshold value of user engagement for a given measure of user exposure) to generate a training model that would enable the advertiser or the page administrator to produce or generate other popular posts in the future. Stated differently, by observing and analyzing user engagement trends of popular posts, an advertiser or a page administrator may improve user engagement statistics for the advertiser's or administrator's page for future posts, or may develop a better understanding of the nature and types of content that are popular with users of the social networking system so as to communicate advertisement content with the social networking system users with improved efficiency and efficacy.

In some embodiments, the social networking system presents 750, to the advertiser or the page administrator, a plurality of posts identified correspondingly as high engagement posts at each of a plurality of measures of exposure. For example, the social networking system provides the advertiser or the page administrator a visual display of a trend of measures of user engagement with the measures of exposure for each of the identified plurality of high engagement posts. The social networking system optionally provides the advertiser a visual display of similar trends for one or more of the reviewed posts that were not identified as high engagement posts. Examples of such trends are illustrated in FIGS. 5a-5b.

In some embodiments, in response to a prompt from the advertiser or the page administrator, the social networking system promotes 760, at a measure of exposure after the given measure of exposure, the identified high engagement post, to one or more additional users of the social networking system. Various examples and illustrations of promoting posts are described with reference to FIGS. 4a-4b. For example, a post may be promoted as a story (e.g., as a sponsored story) published to a viewing user's newsfeed, as an advertisement displayed separately from a viewing user's newsfeed, but alongside the newsfeed, and so on. As explained with reference to FIGS. 4a-4b, the identified high engagement post may be visually emphasized in a viewing user's newsfeed to draw the viewing user's attention to the identified high engagement post. In some embodiments, the additional users to whom the identified high engagement post is promoted, are users who have not directly interacted with the set of reviewed posts. In some embodiments, the additional users to whom the identified high engagement post is promoted, are users who have not viewed or directly interacted with the page.

In some embodiments, the identified high engagement post is promoted to the additional users until a predetermined duration of time (e.g., an advertiser-specified period of promotion validity ΔT shown in FIG. 5b) specified by the advertiser or the page administrator. Alternatively, or in addition, in some embodiments, the identified high engagement post is promoted to the additional users until a target measure of exposure is achieved for the identified high engagement post; the target measure of exposure being an advertiser- or administrator-specified target count of user impressions to be achieved via promotion of the post (e.g., an advertiser- or administrator-specified goal G1 corresponding to a target number of user impressions, as explained with reference to FIG. 5a). Furthermore, in some embodiments, the identified high engagement post is promoted to the additional users until a target measure of engagement events is achieved for the identified high engagement post (e.g., an advertiser- or administrator-specified goal G2 corresponding to a target number of user interactions, as explained with reference to FIG. 5a). In some embodiments, the identified high engagement post is promoted to the one or more additional users based on a monetary budget specified by the advertiser or the page administrator to limit the amount of compensation the advertiser provides the social networking system to present or promote the identified high engagement post, to users. The social networking system may compare an amount of compensation received from the advertiser or the page administrator to the specified budget, and may modify presentation of the identified high engagement post to the additional users based on a difference between the specified budget and the received amount of compensation.

In some embodiments, in response to a prompt from the advertiser or the page administrator, the social networking system emphasizes 770 the identified high engagement post to additional users of the social networking system by moving the identified high engagement post to a top of the page or by visually highlighting the identified high engagement post on the page to draw attention to the identified high engagement post. Various forms of visual highlighting of the identified high engagement post are described with reference to FIGS. 4a-4b above.

### SUMMARY

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments are intended to be illustrative, but not limiting, of the scope of the embodiments, which is set forth in the following claims.

What is claimed is:

1. A method comprising:
reviewing a set of posts associated with a page in a social networking system;
measuring a degree of user engagement with each post of the set of reviewed posts at one or more measures of exposure;
identifying, from the set of reviewed posts, a post having a corresponding degree of user engagement that exceeds a threshold user engagement level for a given measure of exposure, the post identified as a high engagement post; and
notifying an administrator associated with the page of the identified high engagement post.

2. The method of claim 1, wherein a measure of exposure for a particular post of the set of reviewed posts is a time point after a time of creation of the particular post.

3. The method of claim 2, wherein measuring a degree of user engagement with the particular post at the time point after the time of creation of the particular post comprises:
measuring a total count of engagement events associated with the particular post up until the time point;
measuring a total count of user impressions of the particular post up until the particular time point; and
normalizing the total count of engagement events by the total count of user impressions.

4. The method of claim 1, wherein a measure of exposure for a particular post of the set of reviewed posts represents user impressions of the particular post.

5. The method of claim 4, wherein measuring a degree of user engagement with the particular post at a particular aggregate count of prior user impressions comprises:
measuring a total count of engagement events, from among the prior user impressions.

6. The method of claim 1, wherein user engagement with a particular post of the set of reviewed posts comprises an engagement event selected from the group consisting of: user likes for the particular post, user comments on the particular post, and user shares of the particular post.

7. The method of claim 1, wherein measuring a degree of user engagement with a particular post of the set of posts comprises:
determining a likelihood of one or more users of the social networking system performing an engagement event after being presented with the particular post.

8. The method of claim 1, wherein the threshold user engagement level for the given measure of exposure is computed based on a predetermined percentage of a cumulative measure of user engagement with one or more other posts in the social networking system for the given measure of exposure.

9. The method of claim 1, wherein the threshold user engagement level for the given measure of exposure has a predefined relationship with the given measure of exposure.

10. The method of claim 1, further comprising:
presenting to the administrator a plurality of posts identified as high engagement posts at each of a plurality of measures of exposure.

11. The method of claim 1, further comprising:
responsive to a prompt from the administrator, promoting the identified high engagement post to one or more additional users of the social networking system.

12. The method of claim 11, wherein the identified high engagement post is promoted to the one or more additional users until a predetermined duration of time specified by the administrator or by the social networking system.

13. The method of claim 11, wherein the identified high engagement post is promoted to the one or more additional users until a target measure of exposure is achieved for the identified high engagement post, the target measure of exposure being a target count of user impressions.

14. The method of claim 11, wherein the identified high engagement post is promoted to the one or more additional users until a target measure of engagement events is achieved for the identified high engagement post.

15. The method of claim 11, wherein the one or more additional users comprise users who have not directly interacted with the set of reviewed posts.

16. The method of claim 1, further comprising:
responsive to a prompt from the administrator, emphasizing the identified high engagement post to one or more additional users of the social networking system by moving the identified high engagement post to a top of the page or by visually highlighting the identified high engagement post on the page.

17. A computer system comprising:
a processor;
memory coupled to the processor, the memory having encoded thereon instructions that, when executed by the processor, cause the processor to:
review a set of posts associated with a page in a social networking system;
measure a degree of user engagement with each post of the set of reviewed posts at one or more measures of exposure;
identify, from the set of reviewed posts, a post having a corresponding degree of user engagement that exceeds a threshold user engagement level for a given measure of exposure, the post identified as a high engagement post; and
notify an administrator associated with the page of the identified high engagement post.

18. The computer system of claim 17, wherein a measure of exposure for a particular post of the set of reviewed posts is a time point after a time of creation of the particular post.

19. The computer system of claim 18, wherein the instructions further cause the processor to measure a degree of user engagement with the particular post, at the time point after the time of creation of the particular post, by causing the processor to:
measure a total count of engagement events associated with the particular post up until the time point, the engagement events selected from the group consisting of: user likes for the particular post, user comments on the particular post, and user shares of the particular post;
measure a total count of user impressions of the particular post up until the particular time point; and
normalize the total count of engagement events by the total count of user impressions.

20. The computer system of claim 17, wherein a measure of exposure for a particular post of the set of reviewed posts represents an aggregate count of prior user impressions of the particular post.

21. The computer system of claim 20, wherein the instructions further cause the processor to measure a degree of user engagement with the particular post, at a particular aggregate count of prior user impressions, by causing the processor to measure a total count of engagement events, from among the prior user impressions, the engagement events selected from the group consisting of: user likes for the particular post, user comments on the particular post, and user shares of the particular post.

22. A computer program product comprising a non-transitory computer-readable storage medium including instructions that, when executed by a processor, cause the processor to:
review a set of posts associated with a page in a social networking system;
measure a degree of user engagement with each post of the set of reviewed posts at one or more measures of exposure;
identify, from the set of reviewed posts, a post having a corresponding degree of user engagement that exceeds a threshold user engagement level for a given measure of exposure, the post identified as a high engagement post; and
notify an administrator associated with the page of the identified high engagement post.

23. The computer program product of claim 22, wherein a measure of exposure for a particular post of the set of reviewed posts is a time point after a time of creation of the particular post.

24. The computer program product of claim 23, wherein the instructions further cause the processor to measure a degree of user engagement with the particular post, at the time point after the time of creation of the particular post, by causing the processor to:
measure a total count of engagement events associated with the particular post up until the time point, the engagement events selected from the group consisting of: user likes for the particular post, user comments on the particular post, and user shares of the particular post;
measure a total count of user impressions of the particular post up until the particular time point; and
normalize the total count of engagement events by the total count of user impressions.

25. The computer program product of claim 22, wherein a measure of exposure for a particular post of the set of reviewed posts represents an aggregate count of prior user impressions of the particular post.

26. The computer program product of claim 25, wherein the instructions further cause the processor to measure a degree of user engagement with the particular post, at a particular aggregate count of prior user impressions, by causing the processor to measure a total count of engagement events, from among the prior user impressions, the engagement events selected from the group consisting of: user likes for the particular post, user comments on the particular post, and user shares of the particular post.
